(19) United States
(12) Patent Application Publication
(10) Pub. No.: US 2015/0267892 A1
(43) Pub. Date: Sep. 24, 2015

(54) TRANSPARENT MEMBER AND LIGHT EMITTING MODULE

(71) Applicant: ASAHI GLASS COMPANY, LIMITED, Tokyo (JP)

(72) Inventors: Nobuaki IKAWA, Tokyo (JP); Yasuo HAYASHI, Tokyo (JP); Yoko MITSUI, Tokyo (JP); Satoshi TAKEDA, Tokyo (JP); Makoto FUKAWA, Tokyo (JP)

(73) Assignee: ASAHI GLASS COMPANY, LIMITED, Tokyo (JP)

(21) Appl. No.: 14/731,443

(22) Filed: Jun. 5, 2015

Related U.S. Application Data
(63) Continuation of application No. PCT/JP2013/082502, filed on Dec. 3, 2013.

(30) Foreign Application Priority Data
Dec. 7, 2012 (JP) 2012-267751

(51) Int. Cl. F21V 5/00; F21K 99/00; F21V 9/16

(52) U.S. Cl. CPC F21V 5/002; F21V 9/16; F21K 9/56; F21Y 2101/02

(57) ABSTRACT

A transparent member includes a plate having a first surface, and a second surface provided on an opposite side from the first surface. The first surface includes one or a plurality of troughs formed on the first surface, and the first surface contains fluorine atoms.

### CROSS-REFERENCE TO RELATED APPLICATIONS

This application is a continuation application filed under 35 U.S.C. 111(a) claiming the benefit under 35 U.S.C. 120 and 365(c) of PCT International Application No. PCT/JP2013/082502 filed on Dec. 3, 2013, which is based upon and claims the benefit of priority of Japanese Patent Application No. 2012-267751 filed on Dec. 7, 2012, the entire contents of which are incorporated herein by reference.

### BACKGROUND OF THE INVENTION

1. Field of the Invention

The present invention relates to transparent members, and more particularly to a transparent member that may be applied to a light emitting module or the like.

2. Description of the Related Art

Recently, light emitting modules having a light emitting device, such as an LED (Light Emitting Diode), are developed as light sources having a long life and low power consumption.

In general, the light emitting module includes a semiconductor light emitting device, such as the LED, a wavelength conversion member, and a transparent member. The wavelength conversion member includes a fluorescent substance, and has a function to convert a wavelength of light emitted from the light emitting device and emit light having a different wavelength. The transparent member has a function to provide an emission surface from which the light is emitted to the outside.

When such a light emitting module operates, light having a first wavelength is first emitted from the light emitting device. The light emitted from the light emitting device is input to the wavelength conversion member. The light having the first wavelength and input to the wavelength conversion member is partially subjected to a wavelength conversion, to thereby generate light having a second wavelength. The light having the first wavelength and not converted by the wavelength conversion member, and the light having the second wavelength, are combined to form light having a desired wavelength. This light having the desired wavelength is emitted from the transparent member side, so as to emit the light having the desired wavelength outside the light emitting module.

When the light emitting from the light emitting device and/or the wavelength conversion member undergoes total reflection (or internal reflection) within the light emitting module, an amount of light emitted outside the light emitting module through the transparent member decreases, to thereby reduce a luminance of the light emitting module. For this reason, in the light emitting module, it may be preferable to suppress the internal reflection of the light and improve a light extraction efficiency.

In view of the above, light emitting modules having various configurations have been proposed in order to improve the light extraction efficiency. For example, Japanese Laid-Open Patent Publication No. 2010-219163 proposes improving the light extraction efficiency of the light emitting module by forming a plurality of projections on a surface of the transparent member.

However, there are demands to further improve the light extraction efficiency of the light emitting module.

### SUMMARY OF THE INVENTION

The present invention is conceived in view of the above demands, and one object of the present invention is to provide a transparent member that can improve the light extraction efficiency when the transparent member is used in a light emitting module or the like.

According to one aspect of one embodiment, a transparent member may include a plate having a first surface, and a second surface provided on an opposite side from the first surface, wherein the first surface includes one or a plurality of troughs formed on the first surface, and wherein the first surface contains fluorine atoms.

According to another aspect of one embodiment, a light emitting module may include a light emitting device; a transparent member having a first surface, and a second surface provided on an opposite side from the first surface; and a wavelength conversion member arranged between the light emitting device and the transparent member, wherein the first surface includes one or a plurality of troughs formed on the first surface, and wherein the first surface contains fluorine atoms.

### BRIEF DESCRIPTION OF THE DRAWINGS

FIG. 1 is a cross sectional view schematically illustrating a transparent member in one embodiment of the present invention;

FIG. 2 is a diagram schematically illustrating an example of a cross sectional shape of a trough of the transparent member in one embodiment of the present invention;

FIG. 3 is a graph illustrating an example of a profile of a fluorine (F) concentration along a depth direction at a surface of the transparent member in one embodiment of the present invention;

FIG. 4 is a flow chart for explaining an example of a method of fabricating the transparent member in one embodiment of the present invention;

FIG. 5 is a diagram schematically illustrating an example of a configuration of a high-temperature HF (hydrogen fluoride) treatment apparatus;

FIG. 6 is a cross sectional view schematically illustrating an example of a configuration of a light emitting module;

FIG. 7 is a cross sectional view schematically illustrating another example of the configuration of the light emitting module;

FIG. 8 is a diagram illustrating an example of a surface SEM (Scanning Electron Microscope) photograph of a treated surface of a glass plate of an exemplary implementation Ex1; and

FIG. 9 is a diagram illustrating an example of a cross section SEM photograph of the treated surface of the glass plate of the exemplary implementation Ex1.

### DESCRIPTION OF THE PREFERRED EMBODIMENTS

A description will hereinafter be given of embodiments of the present invention with reference to the drawings.

### Transparent Member in One Embodiment

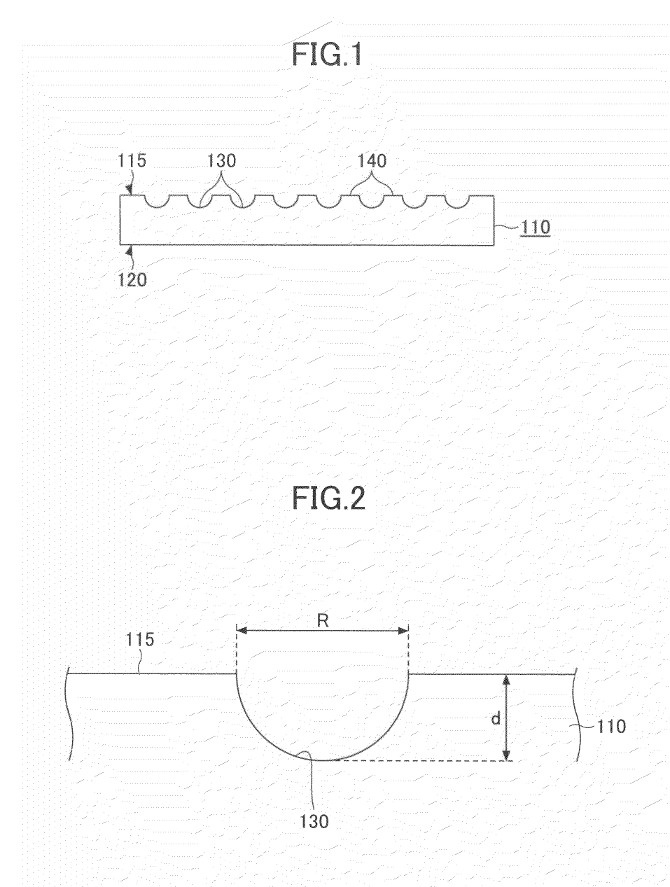

FIG. 1 is a cross sectional view schematically illustrating a transparent member in one embodiment of the present invention.

As illustrated in FIG. 1, a transparent member 110 in one embodiment of the present invention includes a first surface 115, and a second surface 120 provided on an opposite side from the first surface 115.

A plurality of troughs 130 are formed on the first surface 115 of the transparent member 110, and a flat part 140 is formed between two mutually adjacent troughs 130.

The cross sectional shape of the transparent member 110 illustrated in FIG. 1 is merely one example. For example, the number of troughs 130 is not limited to a particular number, and one or more troughs 130 may be formed. In addition, the cross sectional shape of the troughs 130 is not limited to a hemispherical shape illustrated in FIG. 1. Further, in a case in which a large number of troughs 130 are formed on the first surface 115, the flat parts 140 may virtually be unobservable.

Although not observable from FIG. 1, the first surface 115 of the transparent member 110 contains F (fluorine) atoms.

A manner in which the first surface 115 of the transparent member 110 contains the F atoms is not limited to a particular form. For example, the F atoms may be distributed with a profile such that an F atom percentage gradually decreases from the first surface 115 of the transparent member 110 towards an inner direction of the transparent member 110.

Next, a case will be considered in which light input to the second surface 120 of the transparent member 110 passes through the inside of the transparent member 110 and is emitted from the first surface 115 of the transparent member 110.

The transparent member 110 includes the troughs 130 on the first surface 115. Because the troughs 130 are provided, the light propagating through the inside of the transparent member 110 is scattered in various directions at the first surface 115 of the transparent member 110. For this reason, an amount of light undergoing total reflection inside the transparent member 110 is reduced.

In addition, the first surface 115 of the transparent member 110 contains the F atoms. A refractive index of the F atoms is approximately 1.3. Moreover, in a case in which the transparent member 110 is made of glass, resin, plastic, or the like, this transparent member 110 normally has a refractive index of approximately 1.5.

In a case in which the first surface 115 of the transparent member 110 contains no F atoms, the light input to the second surface 120 of the transparent member 110 passes through an interface of the first surface 115 of the transparent member 110 and air, that is, an interface having a refractive index of 1.5/1.0, when the light is emitted from the transparent member 110. A variation range of the refractive index at this interface is relatively large. For this reason, when the light enters this interface, the light is partially reflected.

On the other hand, in the case in which the first surface 115 of the transparent member 110 contains the F atoms, the light input to the second surface 120 of the transparent member 110 passes through an interface of the F-atom-containing first surface 115 of the transparent member 110 and the air, that is, an interface having a refractive index of 1.3/1.0, when the light is emitted from the transparent member 110. At this interface, a sudden variation in the refractive index is significantly suppressed compared to the case in which the first surface 115 contains no F atoms. Particularly in the case in which the F atoms are distributed with the profile such that the F atom percentage gradually decreases from the first surface 115 of the transparent member 110 towards the inner direction of the transparent member 110, the effect of suppressing the variation of the refractive index can be enhanced.

Accordingly, the transparent member 110 can significantly reduce the amount of light reflected at the interface of the first surface 115 and the air, and a large amount of light can be emitted from the first surface 115.

As described above, the first surface 115 of the transparent member 110 is provided with the troughs 130 and contains the F atoms. For this reason, in a case in which the transparent member 110 is applied to a light emitting module, for example, it becomes possible to significantly improve a light extraction efficiency of the light that is emitted from the light emitting module through the transparent member 110.

### Details of Transparent Member in One Embodiment

Next, a more detailed description will be given of specifications or the like of the transparent member 110 in one embodiment of the present invention illustrated in FIG. 1.

The transparent member 110 may be made of any suitable transparent material. For example, the transparent member 110 may be made of glass, resin, plastic, or the like. The transparent member 110 may be a glass article.

In this specification, “transparent” refers to a state in which a total light transmittance is 50% or higher.

In a case in which the transparent member 110 is made of glass, a composition of the glass is not limited to a particular composition. For example, the glass may be soda lime silicate glass, aluminosilicate glass, borate glass, lithium aluminosilicate glass, borosilicate glass, alkali-free glass, or the like. Alternatively, the glass may be any one of the following glass (i)-(iv).

(i) Glass containing 50% to 80% SiO₂, 0.1% to 25% Al₂O₃, 3% to 30% Li₂O+Na₂O+K₂O, 0 to 25% MgO, 0 to 25% CaO, and 0 to 5% ZrO₂, when the composition is represented in mol %;

(ii) Glass containing 50% to 74% SiO₂, 1% to 10% Al₂O₃, 6% to 14% Na₂O, 3% to 11% K₂O, 2% to 15% MgO, 0 to 6% CaO, 0 to 5% ZrO₂, wherein a sum of contents of SiO₂ and Al₂O₃ is 75% or lower, a sum of contents of Na₂O and K₂O is 12% to 25%, and a sum of contents of MgO and CaO is 7% to 15%, when the composition is represented in mol %;

(iii) Glass containing 68% to 80% SiO₂, 4% to 10% Al₂O₃, 5% to 15% Na₂O, 0 to 1% K₂O, 4% to 15% MgO, and 0 to 1% ZrO₂, when the composition is represented in mol %; and

(iv) Glass containing 67% to 75% SiO₂, 0 to 4% Al₂O₃, 7% to 15% Na₂O, 1% to 9% K₂O, 6% to 14% MgO, 0 to 1.5% ZrO₂, wherein a sum of contents of SiO₂ and Al₂O₃ is 71% to 75%, a sum of contents of Na₂O and K₂O is 12% to 20%, and less than 1% CaO in a case in which CaO is included, when the composition is represented in mol %.

In addition, the transparent member 110 may have a plate shape or a film shape. A thickness of the transparent member 110 having the plate shape or the film shape may be in a range of 0.1 mm to 2 mm, and more preferably in a range of 0.5 mm to 1 mm, for example.

The shape of the troughs 130 formed on the first surface 115 of the transparent member 110 is not limited to a particular shape.

In the trough 130, a shape of an opening when the trough 130 is viewed from above the first surface 110 is not limited to a particular shape, and the opening may have an approximately circular shape an approximately oval shape, or an approximately rectangular shape, for example.

Further, the trough 130 may have an approximately hemispherical cross section. In this specification, “hemispherical” not only refers to a shape obtained by cutting a sphere or an ellipsoid exactly in half, but also shapes obtained by cutting an approximate sphere or an approximate ellipsoid so as not to cut along a center of the approximate sphere or the approximate ellipsoid.

FIG. 2 is a diagram schematically illustrating an example of a cross sectional shape of the trough 130 formed on the first surface 115 of the transparent member 110 in one embodiment of the present invention.

As illustrated in FIG. 2, the opening of the trough 130 has a dimension R, and the trough 130 has a depth d in this embodiment. The dimension R of the opening of the trough 130 represents a maximum dimension of the opening. For example, in a case in which the opening has the approximately circular shape, the dimension R is a diameter of the approximately circular shape. In a case in which the opening has the approximately oval shape, the dimension R is a major axis of the oval shape. In a case in which the opening has the approximately rectangular shape, including an approximately trapezoidal shape, the dimension R is a maximum diagonal length of the approximately rectangular shape. Accordingly, in the following description, the dimension R may also be referred to as a “maximum dimension R”.

A ratio of the maximum dimension R of the opening of the trough 130 with respect to the depth d of the trough 130 is prescribed as an aspect ratio A (A=d/R).

An average maximum dimension R of the opening of the trough 130 may be in a range of 20 nm to 2000 nm, preferably in a range of 50 nm to 800 nm, and more preferably in a range of 100 nm to 600 nm, for example. In addition, an average depth d of the trough 130 may be in a range of 20 nm to 1000 nm, and preferably in a range of 35 nm to 200 nm, for example. Further, the aspect ratio A of the opening of the trough 130 may be in a range of 0.1 to 3.0, preferably in a range of 0.2 to 0.7, and more preferably in a range of 0.3 to 0.6, for example.

An area ratio S of the one or more troughs 130 on the first surface 115 may be in a range of 5% to 100%, and preferably 30% or higher. This area ratio S may be 30% or higher, 40% or higher, and 50% or higher. The area ratio S refers to a ratio (represented in %) of the area of the trough 130 occupying a region having a predetermined area on the first surface 115. Accordingly, the area ratio S of 100% indicates that substantially no flat part 140 exists on the first surface 115 in FIG. 1.

As described above, the first surface 115 of the transparent member 110 contains the F atoms.

An F-content (fluorine-content) at the first surface 115 may be in a range of 0.1 wt % to 0.4 wt %, and preferably in a range of 0.2 wt % to 0.3 wt %, for example. Such an F-content at the first surface 115 may be measured by a fluorescent X-ray analysis, for example.

A manner in which the F atoms exist at the first surface 115 is not limited to a particular form, as long as a significant concentration (or amount) of F exists at the first surface 115. For example, the F atoms may exist in any form along the depth direction of the transparent member 110.

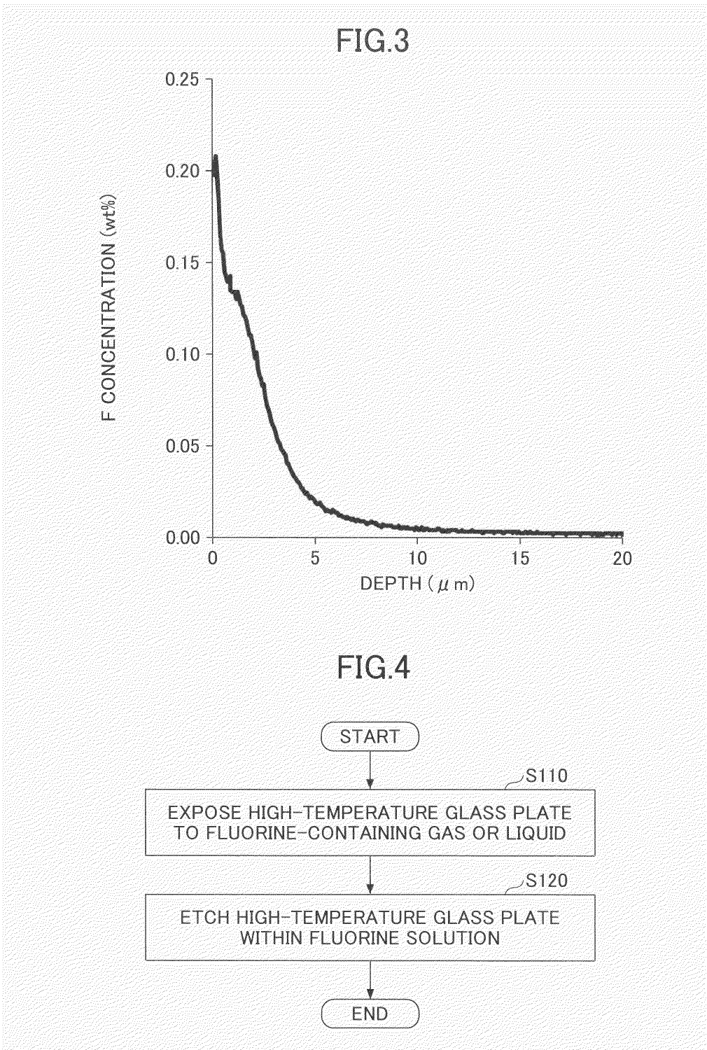

FIG. 3 is a graph illustrating an example of the profile of the F concentration along the depth direction at the first surface 115 of the transparent member 110 in one embodiment of the present invention. This graph is obtained by an SIMS (Secondary Ion Mass Spectrometry) analysis of the first surface 115 of the transparent member 110.

In the example illustrated in FIG. 3, the F atoms are distributed with the profile such that the F atom percentage gradually decreases from the first surface 115 of the transparent member 110 towards the inner direction of the transparent member 110 in a range down to the depth of approximately 10 μm. In the case of the transparent member 110 in this example, the F-content (fluorine-content) at an outermost surface of the transparent member 110 is approximately 0.2 wt %.

However, the profile of the F atom percentage along the depth direction is not limited to that illustrated in FIG. 3. For example, the F atoms may exist with a constant concentration at a certain depth region of the transparent member 11.

### Method of Fabricating Transparent Member

Next, a description will be given of an example of a method of fabricating the transparent member in one embodiment of the present invention.

A description will be given of this example of the method of fabricating the transparent member from a glass plate, for example.

FIG. 4 is a flow chart for explaining this example of the method of fabricating the transparent member in one embodiment of the present invention.

As illustrated in FIG. 4, the method of fabricating the transparent member includes steps S110 and S120. In step S110, a high-temperature glass plate is exposed to a gas or a liquid containing the F atoms. In step S120, the glass plate is etched within the F solution.

Each of steps S110 and S120 will now be described in more detail.

### Step S110 (First Process)

First, the glass plate is prepared. In addition, this glass plate is exposed to the gas or the liquid containing the F atoms, under a high-temperature environment. This step S110 is carried out to include the F atoms at the surface of the glass plate. In addition, in this step S110, micro-troughs having dimensions on the order of nm are formed on the surface of the glass plate.

A composition of the glass plate that is prepared is not limited to a particular composition. For example, the glass plate may be made of soda lime silicate glass, aluminosilicate glass, borate glass, lithium aluminosilicate glass, borosilicate glass, alkali-free glass, or the like.

In addition, the method of fabricating the glass plate is not limited to a particular method, and various methods, such as a float glass process, a downdraw glass process (for example, a fusion process, or the like), a pressing process, or the like may be applied as the fabrication method.

Moreover, the gas or the liquid containing the F atoms may be selected from HF (hydrogen fluoride, in gas or liquid form), freon (for example, chlorofluorocarbon, fluorocarbon, hydrochlorofluorocarbon, hydrofluorocarbon, and halon), hydrofluoric acid, fluorine by itself, trifluoroacetate, carbon tetrafluoride, tetrafluorosilane, phophorous pentafluoride, phosphorous trifluoride, boron trifluoride, nitrogen trifluoride, chlorine trifluoride, and the like, for example.

Various exemplary implementations may exist for step S110.

In a case in which a glass transition temperature is denoted by T_{g}, the temperature of the glass plate may preferably be in a range of (T_{g}−200) ° C. to (T_{g}+300) ° C., and more preferably in a range of (T_{g}−200) ° C. to (T_{g}+250) ° C. The temperature of the glass plate may be in a range of 500° C. to 1000° C., for example.

A description will be given of an example of a method that exposes the glass plate to a treatment gas including HF (hydrogen fluoride), in order to cause the surface of the glass plate to contain F. In the following description, the treatment gas including HF may also be simply referred to as the “treatment gas”, and this method (or step) may also be referred to as the “high-temperature HF treatment method (or step)”.

According to the high-temperature HF treatment method, the glass plate at the high temperature is exposed to the treatment gas. For this reason, the surface of the glass plate may be caused to contain F in a relatively simple manner.

FIG. 5 is a diagram schematically illustrating an example of a configuration of a high-temperature HF treatment apparatus.

As illustrated in FIG. 5, a treatment apparatus 200 includes an injector 210 that supplies the treatment gas to a glass plate 250. The glass plate 250 is transported horizontally, in a direction of an arrow F1 in FIG. 5. The injector 210 is arranged above the glass plate 250.

The injector 210 includes a plurality of slits 215, 220, and 225 that become conduits for the treatment gas. The first slit 215 is provided at a central part of the injector 210 along a vertical direction (or z-axis direction). The second slits 220 are provided along the vertical direction (or z-axis direction), so as to surround the first slit 215. The third slits 225 are provided along the vertical direction, that is, the z-axis direction, so as to surround the second slits 220.

One end (upper part) of the first slit 215 is connected to an HF gas source (not illustrated) and a carrier gas source (not illustrated), and another end (lower part) of the first slit 215 is arranged on the side of the glass plate 250. Similarly, one end (upper part) of the second slits 220 is connected to a diluent gas source (not illustrated), and another end (lower part) of the second slits 220 is arranged on the side of the glass plate 250. One end (upper part) of the third slits 225 is connected to an exhaust system (not illustrated), and another end (lower part) of the third slits 225 is arranged on the side of the glass plate 250.

A distance between a bottom surface of the injector 210 and the glass plate 250 is preferably 50 mm or less. By making this distance 50 mm or less, it is possible to suppress diffusion of unused treatment gas to the atmosphere, and enable a predetermined amount of the treatment gas to positively reach the surface of the glass plate 250. On the other hand, when this distance between the bottom surface of the injector 210 and the glass plate 250 is too short, the possibility of the glass plate 250 and the injector 210 making contact with each other increases.

In a case in which the treatment apparatus 200 having the configuration described above is used to carry out the treatment on the glass plate 250, an HF gas is first supplied from the HF gas source (not illustrated) through the first slit 215 in a direction of an arrow F2. In addition, a diluent gas, such as nitrogen or the like, is supplied from the diluent gas source (not illustrated) through the second slits 220 in a direction of an arrow F3. A carrier gas, such as nitrogen or the like, may be supplied to the first slit 215 in addition to the HF gas.

In this state, the glass plate 250 moves in the direction of the arrow F1. For this reason, when the glass plate 250 passes under the injector 210, the glass plate 250 makes contact with the treatment gas supplied through the first and second slits 215 and 220. As a result, the treatment is carried out the surface of the glass plate 250 and the surface of the glass plate 250 is surface-treated.

The treatment gas supplied to the surface of the glass plate 250 flows horizontally (or x-axis direction) in a direction of an arrow F4 to treat the surface of the glass plate 250, and thereafter flows in a direction of an arrow F4 through the third slits 225 that are connected to the exhaust system (not illustrated) to be exhausted outside the treatment apparatus 200.

A supply rate (or flow rate) of the treatment gas supplied to the glass plate 250 and a transit time in which the glass plate 250 passes under the injector 210 are not limited to particular values. For example, the supply rate of the treatment gas may be in a range of 10 cm/s (centimeters/second) to 200 cm/s, and more preferably in a range of 50 cm/s to 100 cm/s. In addition, the transit time in which the glass plate 250 passes under the injector 210, that is, a time in which the glass plate 250 passes a distance T illustrated in FIG. 5, may be in a range of 1 second to 120 seconds, preferably in a range of 4 seconds to 60 seconds, and more preferably in a range of 4 seconds to 30 seconds, for example.

Accordingly, the glass plate 250 that is transported can be treated by the treatment gas by use of the treatment apparatus 200.

The treatment apparatus 200 illustrated in FIG. 5 is merely one example of the apparatus that is used to carry out the high-temperature HF treatment on the glass plate by supplying the treatment gas including the HF gas, and other apparatuses may be used to carry out the high-temperature HF treatment.

In addition, the glass plate may be exposed to the F-atom-containing gas or liquid under the high-temperature environment by a method other than the high-temperature HF treatment method.

### Step S120 (Second Process)

Next, an etching process using an etchant solution is carried out with respect to the glass plate, the treatment of which by step S110 described above has been completed. The etching process removes a top surface portion of the glass plate, in order to adjust the shape of the troughs 130 formed by step S110 described above.

The etching process may be carried out by dipping the glass plate into the etchant solution, for example.

In this case, the etchant solution may include HF. An HF concentration in the etchant solution is not limited to a particular concentration. For example, the HF concentration in the etchant solution may be in a range of 0.001 wt % to 25 wt %, preferably in a range of 0.01 wt % to 10 wt %, and more preferably in a range of 0.1 wt % to 2 wt %. The HF concentration in the etchant solution affects an etching rate of glass, and the higher the HF concentration, the higher the etching rate.

The etchant solution may further include a conjugate base liquid such as LiOH, NaOH, KOH, RbOH, CsOH, or the like.

An amount of the etchant solution is not limited to a particular amount, but it is preferable that a sufficient amount of the etchant solution is used with respect to the glass plate. For example, 25 ml or more of the etchant solution may be used per 50 cm² surface area of the glass plate.

An etching time, that is, a time for which the glass plate is dipped into the etchant solution, may vary according to the dimensions of the glass plate. For example, the etching time may be on the order of 1 second to 60 seconds. The etching time may preferably be in a range of 10 seconds to 5 minutes (min), and more preferably in a range of 20 seconds to 3 min, for example.

Ultrasonic vibrations may be applied to the glass plate during the etching process. Alternatively, the glass plate may be etched in a state in which a bubbling or an agitation of the etchant solution is performed, for example.

An etching temperature may be in a range of 10° C. to 50° C., and more preferably in a range of 15° C. to 25° C., for example. The etching process may be performed at room temperature (25° C.).

After the etching process is completed, the glass plate is removed from the etchant solution, and the etchant solution is quickly removed from the glass plate by water washing or the like, for example. Thereafter, the glass plate is subjected to a drying process.

By performing steps described above, it is possible to fabricate the transparent member 100 illustrated in FIG. 1, made of glass and having the first surface 115 containing the F atoms and provided with the troughs 130.

The above described method of fabricating the transparent member in one embodiment of the present invention is merely one example, and the transparent member may be fabricated using other fabrication methods. For example, in the fabrication method described above, the etching process using the etchant solution of step S120 may be omitted.

### Application Examples of Transparent Member

Next, a description will be given of application examples of the transparent member in one embodiment of the present invention.

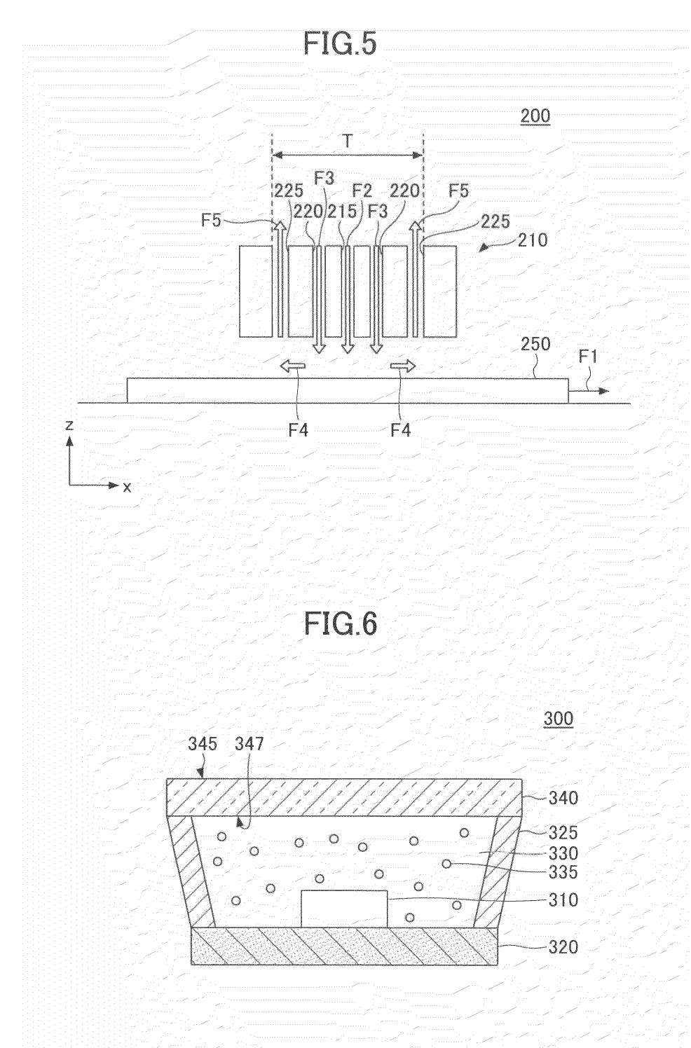

FIG. 6 is a cross sectional view schematically illustrating an example of a configuration of the light emitting module which may be used for a light source or the like, for example.

As illustrated in FIG. 6, an optical module 300 includes a substrate 320, a sealing member (or sealing material) 330, and a transparent member 340. A semiconductor light emitting device 310, such as an LED (Light Emitting Diode), for example, is arranged on the substrate 320.

A sidewall 325 is further provided on the side of the substrate 320 provided with the light emitting device 310. The sidewall 325 may include a reflective member formed on an inner surface thereof, or have at least the inner surface there formed by the reflective member.

The sealing member 330 may be formed by dispersing a wavelength conversion member (or wavelength conversion element) 335, such as a fluorescent substance, within a resin matrix. The sealing member 330 fills a space formed by the substrate 320 and the sidewall 325, so as to completely cover the light emitting device 310.

The transparent member 340 includes a first surfaced 345 and a second surface 347. The transparent member 340 is arranged above the sealing member 330 so that the second surface 347 makes contact with the sealing member 330. In the light emitting module 300, the side of the light emitting module 300 provide with the transparent member 340 becomes a light extraction side.

The transparent member 340 may have the configuration of the transparent member 110 in one embodiment of the present invention described above in conjunction with FIG. 1. More particularly, a plurality of troughs (not illustrated) are formed on the first surface 345 of the transparent member 340, and this first surface 345 contains the F atoms.

When the light emitting module 300 operates, first light having a first wavelength is emitted from the light emitting device 310. This first light is converted into second light having a second wavelength by the wavelength conversion member 335 included within the sealing member 330. The first light and the second light generated inside the light emitting module 300 propagate towards the side of the transparent member 340, that is, upwards in FIG. 6. As described above, the reflective sidewall 325 is arranged on the side surface of the light emitting module 300. For this reason, the first light and the second light generated inside the light emitting module 300 will not be emitted to the outside through the sidewall 325 of the light emitting module 300.

In a case in which the transparent member 340 is not provided within the light emitting module 300, the first light and the second light would be emitted to the outside by passing through an interface of the sealing member 330 and air. At this interface, the refractive index varies from the refractive index (approximately 1.5) of the resin matrix forming the sealing member 330 to the refractive index (1.0) of the air. Accordingly, the first light and the second light passing through this interface are subject to a relatively large variation in the refractive index. Consequently, a part of the first light and the second light may undergo internal reflection, and there is a possibility of not being able to extract sufficient amounts of the first light and the second light from the light emitting module 300.

However, in this example, the light emitting module 300 includes the transparent member 340. This transparent member 340 has the configuration of the transparent member 110 in one embodiment of the present invention described above in conjunction with FIG. 1.

In this case, when the first light and the second light are emitted from the transparent member 340, the first light and the second light pass through the interface of the first surface 345 containing the F atoms and the air, that is, the interface having the refractive index of 1.3/1.0. At this interface, a sudden variation in the refractive index is significantly suppressed compared to the case in which the first surface 345 contains no F atoms. Accordingly, in the light emitting module 300, the transparent member 340 can significantly reduce the amount of light reflected at the interface of the first surface 345 of the transparent member 340 and the air, and a large amount of light can be emitted from the first surface 345.

In addition, the micro-troughs are formed on the first surface 345 of the transparent member 340, and the first light and the second light are scattered in various directions at the first surface 345 of the transparent member 340. For this reason, it is possible to reduce the amount of light undergoing total reflection inside the transparent member light emitting module 300.

Due to the effects described above, the light extraction efficiency can be improved significantly in the light emitting module 300.

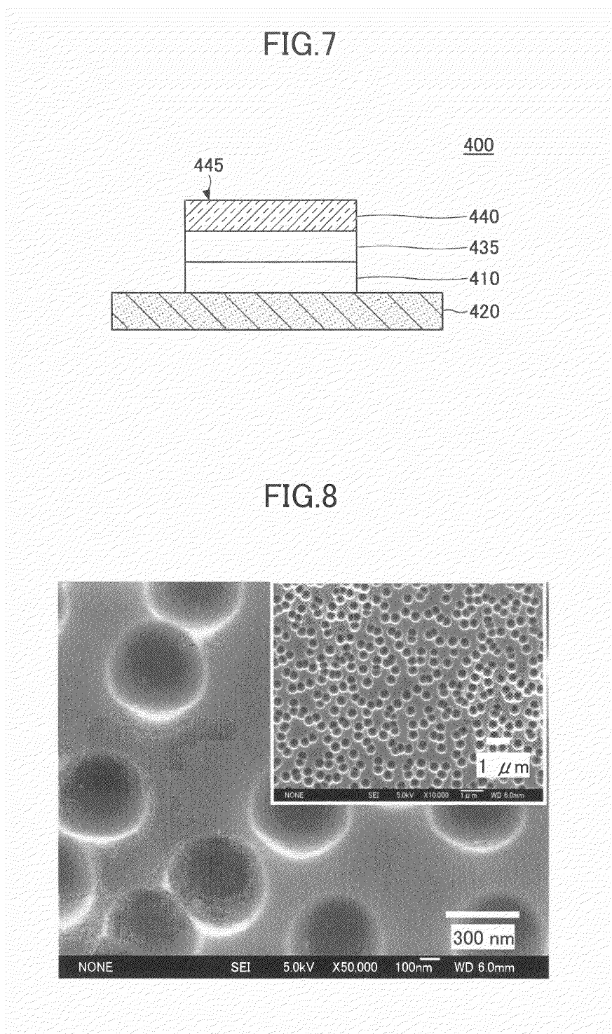

FIG. 7 is a cross sectional view schematically illustrating another example of the configuration of the light emitting module.

As illustrated in FIG. 7, an optical module 400 includes a substrate 420, a wavelength conversion member (or wavelength conversion element) 435, and a transparent member 440. A light emitting device 410, such as an LED, for example, is arranged on the substrate 420. In the light emitting module 400, the side of the transparent member 440 becomes a light extraction surface.

The wavelength conversion member 435 includes a fluorescent substance, and can convert first light emitted from the light emitting device 410 and having a first wavelength into second light having a second wavelength.

The transparent member 440 may have the configuration of the transparent member 110 in one embodiment of the present invention described above in conjunction with FIG. 1. More particularly, a plurality of troughs (not illustrated) are formed on a first surface 445 of the transparent member 440, and this first surface 445 contains the F atoms.

The effects described above for the light emitting module 300 can also be obtained in the light emitting module 400. Hence, it may be readily understood that, due to the effects described above, the light extraction efficiency can also be improved significantly in the light emitting module 400.

### Exemplary Implementations

Next, a description will be given of exemplary implementations of the present invention. In the following description, Ex1 through Ex13 are exemplary implementations, and Ex14 is a comparison example.

### Ex1

The method described above in conjunction with FIG. 4, including step S110 (first process) and step S120 (second process), was used to fabricate the glass plate (hereinafter also referred to as “a glass plate of exemplary implementation Ex1”) as the transparent member.

The first process was carried out by the high-temperature HF treatment method described above. In addition, the treatment apparatus 200 illustrated in FIG. 5 was used to treat the glass plate using the treatment gas.

The glass plate included 64.3% SiO₂, 8.0% Al₂O₃, 12.5% Na₂O, 4.0% K₂O, 10.5% MgO, 0.1% CaO, 0.1% SrO, 0.1% BaO, and 0.5% ZrO₂ in mol % representation.

A mixture gas of nitrogen gas and a HF gas was used for the treatment gas. A HF gas concentration within the treatment gas was 1.2 vol %. A supply rate of the treatment gas was 60 cm/s. A treatment temperature (temperature of the glass plate at the time of the treatment) was 750° C. In addition, a treatment time (a transit time in which the glass plate passes under the injector) was 3 seconds.

Next, the second process was carried out to subject the glass plate (size of approximately 50 mm×approximately 50 mm×approximately 0.7 mm) to an etching process in a HF solution. An HF concentration within the HF solution was 1 wt %. In addition, an etching time was 30 seconds, and a temperature of the HF solution was 25° C. The etching process was carried out in a state in which the HF solution and the glass plate are stationary.

The glass plate was dipped completely into the HF solution, and after lapse of 30 seconds, the glass plate was removed from the HF solution, water-washed, and dried.

As a result, the glass plate of the exemplary implementation Ex1 was obtained.

### Ex2 Through Ex13

Glass plates of exemplary implementations Ex2 through Ex13 were fabricated by a method similar to the method used to fabricate the exemplary implementation Ex1. However, when fabricating the glass plates of the exemplary implementations Ex2 through Ex13, a part of the conditions related to the first process and/or a part of the conditions related to the second process were modified from the conditions used to fabricate the glass plate of the exemplary implementation Ex1.

Fabrication conditions for the glass plates of the exemplary implementations Ex1 through Ex13 are summarized in Table 1.

TABLE 1

| EXEMPLARY | | | | | |
|---|---|---|---|---|---|
| IMPLEMEN- | | | | | |
| TATION OR | FIRST PROCESS | | | SECOND PROCESS | |
| COMPARISON | HF CONCEN- | TEMPER- | HF GAS SUPPLY | HF CONCEN- | ETCHING |
| EXAMPLE | TRATION (vol %) | ATURE (° C.) | RATE (cm/s) | TRATION (wt %) | TIME (s) |
| Ex1 | 1.2 | 750 | 60 | 1.0 | 30 |
| Ex2 | 1.2 | 750 | 60 | 1.0 | 60 |
| Ex3 | 1.7 | 750 | 60 | 1.0 | 30 |
| Ex4 | 1.7 | 750 | 60 | 1.0 | 60 |
| Ex5 | 2.0 | 750 | 75 | 0.5 | 30 |
| Ex6 | 2.0 | 750 | 75 | 0.5 | 40 |
| Ex7 | 2.0 | 750 | 75 | 0.5 | 50 |
| Ex8 | 2.0 | 750 | 75 | 0.5 | 60 |
| Ex9 | 2.0 | 750 | 75 | 0.5 | 120 |
| Ex10 | 2.0 | 750 | 75 | 0.5 | 180 |
| Ex11 | 2.0 | 630 | 75 | 0.1 | 60 |
| Ex12 | 2.0 | 630 | 75 | 0.2 | 60 |
| Ex13 | 2.0 | 630 | 75 | 0.3 | 60 |
| Ex14 | — | — | — | 1.0 | 60 |

Conditions not illustrated in Table 1 are the same for the exemplary implementations Ex1 through Ex13.

### Ex14

With respect to the glass plate fabricated by the float glass process, the first process was not carried out and only the second process was carried out, in order to fabricate the glass plate of the comparison example Ex14.

A composition of the glass plate of this comparison example Ex14 was the same as the composition used for the glass plates of the exemplary implementations Ex1 through Ex13. In addition, the conditions of the second process were the same as the conditions used for the exemplary implementation Ex2.

Fabrication conditions for the glass plate of the comparison example Ex14 are summarized in Table 1.

### Evaluation

Next, various evaluations described hereunder were performed using the glass plates of the exemplary implementations Ex1 through Ex13 and the comparison example Ex14.

### Evaluation of Troughs

An FE-SEM (Field Emission-Scanning Electron Microscope) was used to observe the surface and the cross section of each of the glass plates. In each of the glass plates of the exemplary implementations Ex1 through Ex13, the surface that is the observation target was the surface (hereinafter also referred to as the “treated surface”) to which the treatment gas is sprayed during the first process. On the other hand, in the glass plate of the comparison example Ex14, the surface that is the observation target was one of the two surfaces on opposite sides of the glass plate since there is no difference in the treatment performed on the two surfaces. In the following description, the surface of the glass plate of the comparison example Ex14, that is the observation target, may also be referred to as the “treated surface”.

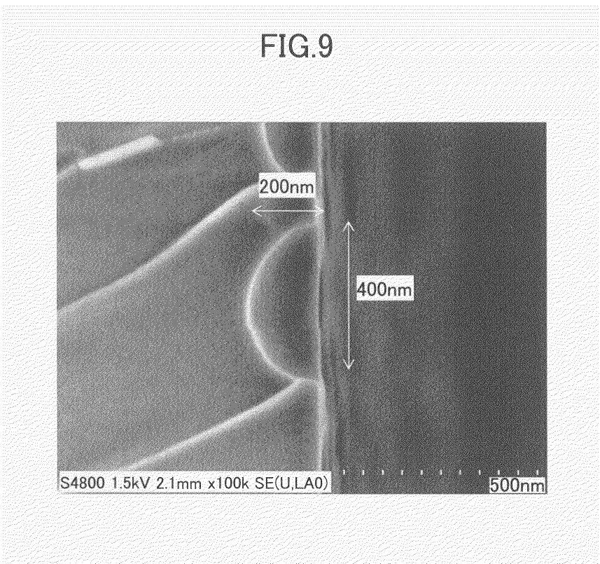

FIG. 8 is a diagram illustrating an example of a surface SEM (Scanning Electron Microscope) photograph of the treated surface of the glass plate of the exemplary implementation Ex1, as a reference. In addition, FIG. 9 is a diagram illustrating an example of a cross section SEM photograph of the treated surface of the glass plate of the exemplary implementation Ex1, as a reference.

From these SEM photographs, it was observed that a large number of approximately hemispherical troughs are formed on the treated surface of the glass plate of the exemplary implementation Ex1. A large number of such approximately hemispherical troughs was also observed on the treated surface of the glass plate of each of the exemplary implementations Ex2 through Ex13. The number of troughs formed on the treated surface had a tendency to increase as the treatment temperature of the first process became lower. In addition, the maximum dimension R of the opening of the trough and the depth d of the trough had a tendency to increase as the HF concentration becomes higher and the etching time becomes longer in the second process.

On the other hand, no trough was observed on the treated surface of the glass plate of the comparison example Ex14.

The maximum dimension R of the opening of the trough (or trough opening) formed on the treated surface, the depth d of the trough, the aspect ratio A=d/R, and the area ratio S of the trough were measured from the observation results of the treated surface of each of the glass plates.

The maximum dimension R of the trough opening and the depth d of the trough were computed by averaging the values obtained for each of the troughs. In addition, the area ratio S of the trough was computed from a ratio of the trough opening occupying the treated surface of each of the glass plates. More particularly, the area ratio S of the trough was obtained by the following procedure. First, the SEM was used to measure the number of troughs existing in an arbitrary 3 μm×3 μm rectangular region on the treated surface of the glass plate, and to measure the dimension of the trough opening. Next, the area occupied by the trough with respect to the entire measured region was computed from the measured values of the number of troughs and the dimension of the trough opening, as the area ratio S of the trough.

The evaluation results of the exemplary implementations Ex1 through Ex13 and the comparison example Ex14, such as the maximum dimension R of the trough opening, the depth d of the trough, the aspect ratio A, and the area ratio S, are summarized in Table 2. In the glass plate of the comparison example Ex14, no trough was observed on the treated surface, and thus, the evaluation results for the maximum dimension R, the depth d, and the aspect ratio A are indicated as “-”, and the area ratio S is indicated as “0”.

TABLE 2

| | EVALUATION RESULTS | | | | | |
|---|---|---|---|---|---|---|
| EXEMPLARY | MAXIMUM | | | | | |
| IMPLEMENTATION | DIMENSION R | | | | | |
| OR | (nm) OF | DEPTH d | | AREA | SURFACE F | LIGHT |
| COMPARISON | TROUGH | (nm) OF | ASPECT | RATIO S | CONCENTRATION | EXTRACTION |
| EXAMPLE | OPENING | TROUGH | RATIO A | (%) | (wt %) | EFFICIENCY |
| Ex1 | 400 | 200 | 0.5 | 54 | 0.14 | 1.75 |
| Ex2 | 800 | 200 | 0.25 | 99 | 0.14 | 1.75 |
| Ex3 | 300 | 150 | 0.5 | 34 | 0.16 | 1.75 |
| Ex4 | 600 | 150 | 0.25 | 99 | 0.16 | 1.75 |
| Ex5 | 200 | 100 | 0.5 | 10 | 0.18 | 1.5 |
| Ex6 | 200 | 100 | 0.5 | 26 | 0.18 | 1.5 |
| Ex7 | 250 | 130 | 0.5 | 28 | 0.17 | 1.25 |
| Ex8 | 300 | 150 | 0.5 | 37 | 0.17 | 1.25 |
| Ex9 | 400 | 150 | 0.4 | 87 | 0.17 | 1.75 |
| Ex10 | 500 | 150 | 0.3 | 100 | 0.16 | 1.5 |
| Ex11 | 50 | 35 | 0.7 | 31 | 0.35 | 1.75 |
| Ex12 | 100 | 50 | 0.5 | 49 | 0.33 | 1.75 |
| Ex13 | 250 | 50 | 0.2 | 99 | 0.32 | 1.75 |
| Ex14 | — | — | — | 0 | DETECTION | 1.0 |
| | | | | | LIMIT OR | |
| | | | | | LOWER | |

### Fluorine Concentration Analysis

Next, the F concentration of the treated surface was analyzed using each of the glass plates of the exemplary implementations Ex1 through Ex13 and the comparison example Ex14. The F concentration was measured using an X-ray fluorescence Spectrometer (ZSX Primus II manufactured by Rigaku Corporation).

The evaluation results of the surface F concentration of the exemplary implementations Ex1 through Ex13 and the comparison example Ex14 are summarized in Table 2.

From these evaluation results, it was confirmed that the treated surface of each of the glass plates of the exemplary implementations Ex1 through Ex13 contains F concentration of at least 0.14 wt % or higher. On the other hand, the F concentration of the treated surface of the glass plate of the comparison example Ex14 was the detection limit or lower.

Similar measurements were performed after polishing approximately 50 μm of the treated surface of each of the glass plates of the exemplary implementations Ex1 through Ex13. As a result, it was confirmed that the polished treated surface of each of the glass plates of the exemplary implementations Ex1 through Ex13 contains no F atoms, that is, the F concentration is the detection limit or lower. From these results, it was confirmed that in each of the glass plates of the exemplary implementations Ex1 through Ex13, the treated surface contains the F atoms only in a vicinity of the treated surface.

### Measurements of Light Extraction Efficiency

Next, light emitting modules were fabricated using the glass plates of the exemplary implementations Ex1 through Ex13 and the comparison example Ex14, and the light extraction efficiency of each of the light emitting modules were measured.

The fabricated light emitting modules had the configuration described above in conjunction with FIG. 6. A commercially available blue LED chip package (Platinum Dragon Blue manufactured by OSRAM GmbH) was used for the part of the light emitting modules other than the transparent member. This package included a light emitting device (blue LED device) mounted on an opaque ceramic substrate, a ceramic sidewall having a reflection layer on an inner surface thereof, and a resin layer filling a space surrounded by the sidewall and the substrate and covering the light emitting device.

The glass plates of the exemplary implementations Ex1 through Ex13 and the comparison example Ex14 were used for the transparent member. The glass plate was arranged in an upper part of the package via glycerin so that the treated surface faces the outer side.

Unlike the light emitting module illustrated in FIG. 6, the resin layer included no wavelength conversion element in the fabricated light emitting modules. Accordingly, in these fabricated light emitting modules, the light extraction efficiency was measured using blue light as the measuring target.

In the following description, the light emitting modules fabricated using the glass plates of the exemplary implementations Ex1 through Ex13 and the comparison example Ex14 may also be referred to as “light emitting modules of the exemplary implementations Ex1 through Ex13 and the comparison example Ex14”. For comparison purposes, a reference light emitting module was also fabricated using, as the transparent member, a glass plate having a composition similar to that of the glass plate of the comparison example Ex14 but not subjected to the first and second processes.

The light extraction efficiency was measured using an LED total luminous flux measurement system (available through Spectra Co-op) provided with a 6-inch integrating-sphere. The amount of light emitted from the transparent member side was measured by the LED total luminous flux measurement system, in a state in which a current of 350 mA is applied between the two terminals of the light emitting device in each of the light emitting modules. The light extraction efficiency was defined as a rate of improvement of the amount of light that increased by the provision of the transparent member, with respect to the amount of light emitted from the blue LED.

The light extraction efficiency of each of the light emitting modules was normalized using the value of the light extraction efficiency obtained by the reference light emitting module as a base (1.0).

The measured results of the light extraction efficiency obtained for each of the glass plates of the exemplary implementations Ex1 through Ex13 and the comparison example Ex14 are summarized as the evaluation results under the light extraction efficiency column in Table 2.

From these measured results or evaluation results, it was confirmed that the light extraction efficiencies of the light emitting modules of the exemplary implementations Ex1 through Ex13 can be improved to 1.25 times to 1.75 times the light extraction efficiency of the reference light emitting module. On the other hand, it was found that the light extraction efficiency of the light emitting module of the comparison example Ex14 is virtually the same as the light extraction efficiency of the reference light emitting module.

Accordingly, it was confirmed that the light extraction efficiency can be improved significantly when the glass plates of the exemplary implementations Ex1 through Ex13 having the troughs formed on the treated surface and containing the F atoms at the treated surface are used, when compared to the glass plate of the comparison example Ex14 having no troughs formed on the treated surface and containing no F atoms at the treated surface.

The embodiments and the exemplary implementations described above may be utilized in the light emitting modules or the like having the transparent member, for example.

According to the embodiments and the exemplary implementations of the present invention, it is possible to improve the light extraction efficiency of the transparent member.

Further, the present invention is not limited to these embodiments and exemplary implementations, but various variations, modifications, or substitutions may be made without departing from the scope of the present invention.

What is claimed is:

1. A transparent member comprising:
a plate having a first surface, and a second surface provided on an opposite side from the first surface,
wherein the first surface includes one or a plurality of troughs formed on the first surface, and
wherein the first surface contains fluorine atoms.

2. The transparent member as claimed in claim 1, wherein an area ratio of the one or plurality of troughs on the first surface is in a range of 5% to 100%.

3. The transparent member as claimed in claim 1, wherein the one or plurality of troughs has an average maximum dimension R in a range of 20 nm to 2000 nm.

4. The transparent member as claimed in claim 1, wherein a ratio A=d/R of an average maximum dimension R of an opening of the one or plurality of troughs with respect to an average depth d of the one or plurality of troughs is in a range of 0.1 to 3.0.

5. The transparent member as claimed in claim 1, wherein the fluorine atoms are distributed with a profile such that a fluorine atom percentage gradually decreases from the first surface towards the second surface along a depth direction of the one or plurality of troughs.

6. The transparent member as claimed in claim 1, wherein a fluorine atom percentage at the first surface is 0.1 wt % or higher.

7. The transparent member as claimed in claim 1, wherein the one or plurality of troughs has an approximately hemispherical shape.

8. A light emitting module comprising:
a light emitting device;
a transparent member having a first surface, and a second surface provided on an opposite side from the first surface; and
a wavelength conversion member arranged between the light emitting device and the transparent member,
wherein the first surface includes one or a plurality of troughs formed on the first surface, and
wherein the first surface contains fluorine atoms.

9. The light emitting module as claimed in claim 8, wherein an area ratio of the one or plurality of troughs on the first surface of the transparent member is in a range of 5% to 100%.

10. The light emitting module as claimed in claim 8, wherein the one or plurality of troughs on the first surface of the transparent member has an average maximum dimension R in a range of 20 nm to 2000 nm.

11. The light emitting module as claimed in claim 8, wherein a ratio A=d/R of an average maximum dimension R of an opening of the one or plurality of troughs on the first surface of the transparent member with respect to an average depth d of the one or plurality of troughs is in a range of 0.1 to 3.0.

12. The light emitting module as claimed in claim 8, wherein the fluorine atoms are distributed with a profile such that a fluorine atom percentage gradually decreases from the first surface of the transparent member towards the second surface of the transparent member along a depth direction of the one or plurality of troughs.

13. The light emitting module as claimed in claim 8, wherein a fluorine atom percentage at the first surface of the transparent member is 0.1 wt % or higher.

14. The transparent member as claimed in claim 8, wherein the one or plurality of troughs on the first surface of the transparent member has an approximately hemispherical shape.
